(19) United States
(12) Patent Application Publication
(10) Pub. No.: US 2002/0178378 A1
(43) Pub. Date: Nov. 28, 2002

(54) Secure intrusion detection system

(76) Inventor: Geoffrey Shively, Newport Beach, CA (US)

Correspondence Address: STETINA BRUNDA GARRED & BRUCKER, 75 ENTERPRISE, SUITE 250, ALISO VIEJO, CA, 92656, US

(21) Appl. No.: 09/865,377

(22) Filed: May 25, 2001

(51) Int. Cl. H04L 9/00

(52) U.S. Cl. 713/201

(57) ABSTRACT

A system and method for performing secure intrusion detection on a network are disclosed. The system comprises an network security device in communication with an Internet. The network security device forwards data to a router and a network operations center via straight through connections. The network security device is invisible to devices on the Internet. Therefore, attacks via the Internet are prevented.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to computer security systems, and more particularly to a secure intrusion detection system.

The proliferation of outsourced data centers has run parallel to the growth of the Internet, e-commerce and web hosting business functions. In the past, companies have built and hosted their own data centers complete with hundreds of tape-to-tape IBM®, Sperry Univac®, and/or Digital Equipment Corporation (DEC)® mainframe computers. Such facilities also require significant Management Information Systems (MIS) personnel for operating and maintaining the data. In recent years, hundreds of data centers have been built to service the increasing demand for offsite data access. Outsourcing has become the primary option for most companies.

While some large enterprises still build and maintain their own corporate data centers, more and more businesses are co-locating their servers containing mission critical systems and data. Colocation facilities generally provide double and triple redundancy with respect to bandwidth requirements and power requirements that are cost prohibitive for all but large corporate data centers.

Customers of colocation facilities, in particular business-to-business (B2B) companies conducting large numbers of transactions, are demanding more and more service in many areas. Security and up time are critical for those with servers at a colocation center. For example, damages from hacker exploits and attacks cause significant losses or downtime for Internet Service Providers (ISPs).

Recently, major information technology (IT) players have had their systems “taken down” by little more than a teenager with Internet access and a malicious mind set. Thus, Internet security is a primary concern of IT executives.

A denial of service (DoS) attack denies legitimate Internet users of the ability to access a particular website or network service, such as e-mail, due to a temporary loss of all network connectivity and services. In a worst case example, a website typically accessed by millions of people can be forced to temporarily cease operation. Although this type of security breach does not usually result in the theft of information or other security loss, it can cost the victims a significant amount of time and money.

In the market of intrusion detection systems (IDSs), there are two types of protection: software IDSs and hardware IDSs. There are numerous flaws with both types of intrusion detection systems, for example, a typical IDS is expensive (e.g. $100,000.00 for a single-user license). Regardless of the cost of the IDS, additional expense is incurred for a security expert to monitor the system. Another problem with prior art systems is that the customer must typically rely on the software manufacturer for security updates.

As shown in the prior art system of FIG. 1, IDSs and firewalls monitor the Internet connection on the same line that they are protecting. IDSs can be tapped in before the firewall (as shown in FIG. 1) and/or after the firewall. As shown FIG. 1, prior art IDSs do not have a real-time monitoring capability. Data may be transmitted from the IDS to a remote monitoring system. This method is inefficient because it uses half of the bandwidth for the actual service being protected, and the other half to mirror the data and send it to the remote monitoring system. Another problem is that routers and firewalls are true (visible) devices on a network and can be attacked themselves, allowing the entire network to be disabled by an outsider, no matter how redundant the network. Furthermore, firewalls have rules that when an attack occurs, the firewall can take the steps necessary to block the attack and any other unauthorized service. If there is a perceived attack that is not actually an attack, a false alarm inappropriately blocks a service. As a result, a client's website or server farm is down until a technician can personally come out, perform an investigation and reset the system. Significant costs result from such unnecessary down time.

Thus, a need exists for an intrusion detection system that ensures that systems and web-based applications are always up.

### BRIEF SUMMARY OF THE INVENTION

The present invention provides a system and method for performing secure intrusion detection on a network. The system comprises a network security device in communication with an Internet. The network security device comprises: a housing having an internal surface and an external surface, the internal surface encasing circuitry for receiving data from the Internet and forwarding the received data to a router and a network operations center, wherein the data is forwarded to the router and the network operations center via straight through connections, whereby the network security device is invisible to devices on the Internet and thereby prevents attacks via the Internet; a line in port on the external surface of the housing for accepting an Internet connection line, the Internet connection line configured to transfer data between the Internet and the network security device; a line out port on the external surface of the housing for completing a path between the Internet and the network security device; and a direct administration line on the external surface of the housing for providing a direct link to the network operations center.

In accordance with other aspects of the invention, the network security device further comprises an S-link on the external surface of the housing for connecting the network security device to another network security device.

In accordance with yet other aspects of the invention, the network security device further comprises at least one indicator for providing status of the network security device.

In accordance with still other aspects of the invention, the Internet connection line can transfer data from a colocation host, a managed service provider or a data center host.

In accordance with further aspects of the invention, the method for performing network security using the network security device comprises: receiving data from an Internet; and forwarding the data received from the Internet to a router and to a network operations center via direct connections between the network, whereby the network security device is invisible to devices on the Internet and thereby prevents attacks via the Internet.

### BRIEF DESCRIPTION OF THE DRAWINGS

These as well as other features of the present invention will become more apparent upon reference to the drawings wherein:

FIG. 1 is a block diagram of a prior art intrusion detection system;

FIG. 2 is a block diagram of an intrusion detection system formed in accordance with the present invention; and

FIG. 3 illustrates the Invisiwall™ device of FIG. 2.

### DETAILED DESCRIPTION OF THE INVENTION

The present invention is a secure intrusion detection system (IDS). As shown in the figures and described in further detail below, the present invention uses a device 40 (known herein as an Invisiwall™ device) to route data from an Internet Connection Line 32 (e.g., a colocation host, a managed service provider, a data center host, etc.) to both a router 34 and an onsite network operations center (NOC) 42. The Invisiwall™ device 40 is invisible to the outside world, and is thus more secure from outside attacks by an attacker 44. The Invisiwall™ device 40 is invisible to the outside world (e.g., Internet users) because there are no media access control (MAC) addresses on any of the ports of the Invisiwall™ device 40. The device connection is a straight through connection with no processing of data going in the Line In port 50 or Line Out port 54 being performed by the Invisiwall™ device 40. The devices receiving information from the Invisiwall™ device (e.g., router 34 and local onsite Invisiwall™ NOC 42) tap into the feed to receive the data from the Invisiwall™ device 40. The present invention conducts all monitoring at the local onsite NOC 42 to eliminate unwarranted bandwidth consumption and other network security concerns. This onsite monitoring allows for full-time security and monitoring at a fraction of the cost that would be required for a customer to perform their own monitoring.

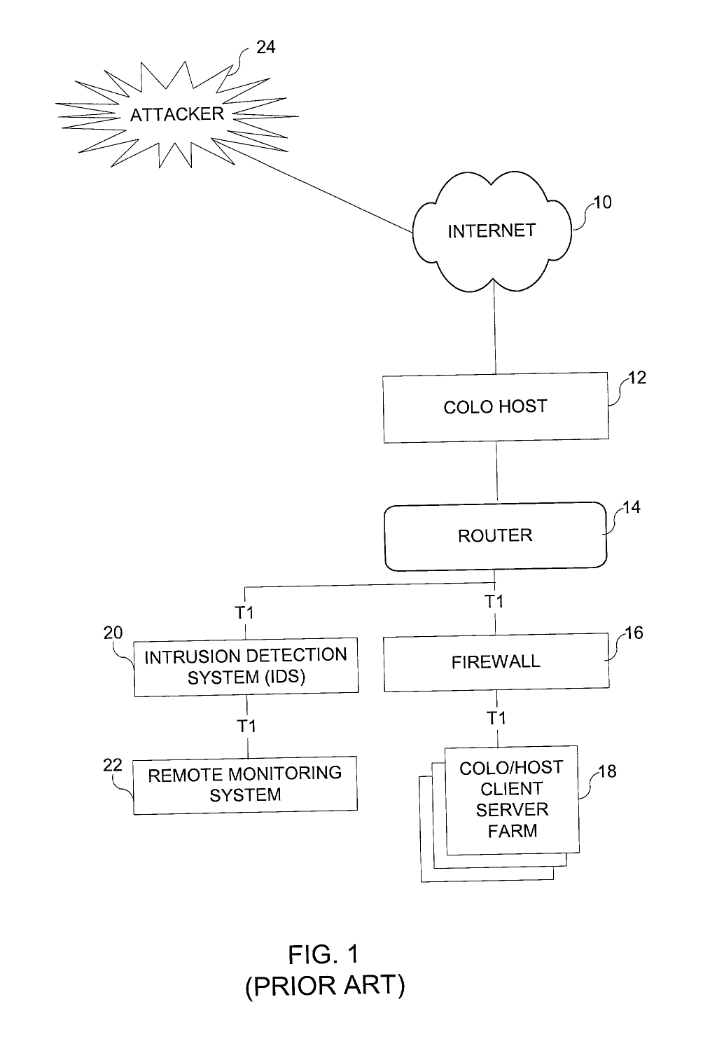

Referring now to the drawings wherein the showings are for purposes of illustrating preferred embodiments of the present invention only, and not for purposes of limiting the same, FIG. 1 is a block diagram of a prior art intrusion detection system. As described above, typical prior art intrusion detection systems, such as the one shown in FIG. 1 are connected to an Internet 10 via a colocation host 12. For example an ISP can place its network router 14 on the premises of the company offering switching services with other ISPs. The router 14 then routes information to the Colo/Host server farm 18 via a firewall 16. Additionally, a duplicate (e.g., mirror image) of the information is transmitted to an IDS 20. The IDS 20 can forward the information to a remote monitoring system 22. In prior art systems, such as the one shown in FIG. 1, because the router 14 and firewall 16 are true (visible) devices on a network, they can be attacked by an attacker 24.

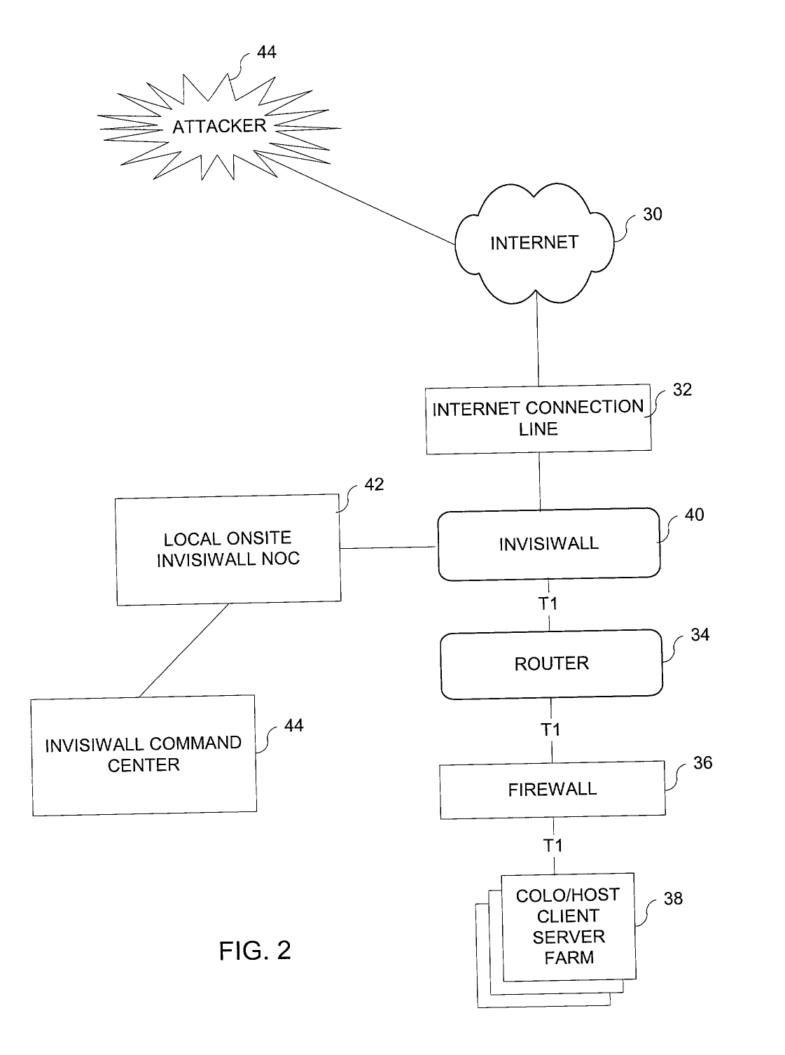

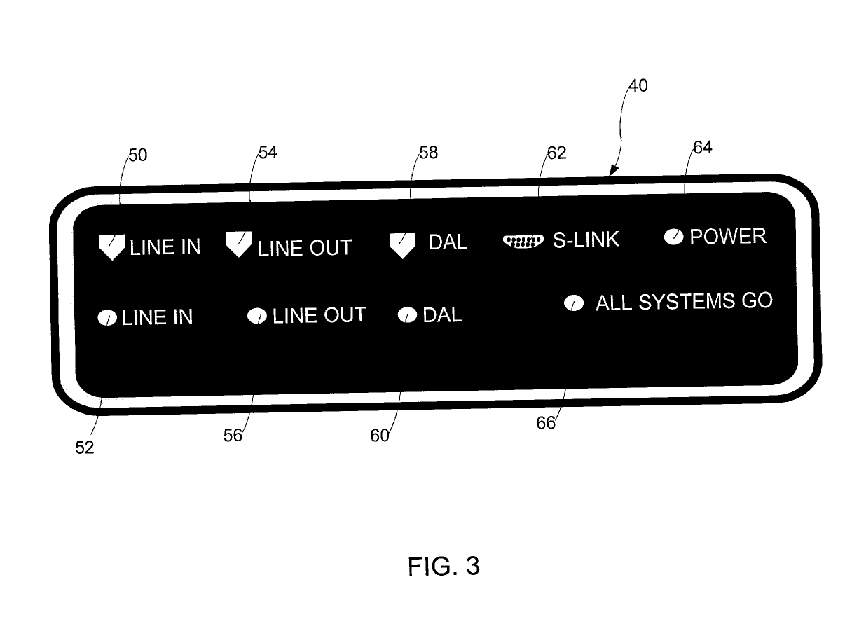

FIG. 2 is a block diagram of a secure intrusion detection system formed in accordance with the present invention. The present invention includes an Internet Connection Line 32 (e.g., a colocation host, a managed service provider, a data center host, etc.) that is connected to an Internet 30. Unlike the prior art systems, the Internet Connection Line 32 communicates with a security device 40 that is not visible to devices on the Internet 30, and thus is not visible to an attacker 44. The security device 40 (also referred to as the Invisiwall™ device herein) is shown in FIG. 3.

FIG. 3 is an illustration of the front panel of an exemplary Invisiwall™ device 40 formed in accordance with the present invention. The exemplary Invisiwall™ device 40 shown in FIG. 3, includes four ports: a Line In port 50, a Line Out port 54, a Direct Administration Line (DAL) 58, and an S-Link port 62. The Line In port 50 is the Internet connection line in from an ISP. The Line Out port 54 is an Internet connection line out that completes the path to the network. The DAL port 58 is a direct link to an onsite Invisiwall™ NOC 42. The S-Link port 62 is used to link multiple Invisiwall™ devices together for multiple connections.

As shown in the exemplary embodiment of FIG. 3, the Invisiwall™ device may include indicators, for example, light-emitting diodes,(LEDs), used to provide a user with information about system status. For example, a power indicator 64 indicates whether power to the Invisiwall™ device 40 is turned on. A Line In indicator 52 indicates whether there is a line in the Line In port 50. Similarly, a Line Out indicator 56 indicates whether there is a line in the Line Out port 54. A DAL indicator 60 indicates whether there is a line in the DAL port 58. An All Systems Go indicator 66 indicates whether all appropriate connections have been made and data is being forwarded to the router and the NOC.

As shown in FIG. 2, the Invisiwall™ device 40 of the present invention forwards information between the Internet Connection Line 32 and a router 34. No processing is performed on the data, rather the Invisiwall™ device 40 simply forwards the information to the device using a direct connection, similar to a splitter. A router is a device, or software in a computer that determines the next network point to which a packet should be forwarded toward its destination. Preferably, communications between the Invisiwall™ device 40 and the router 34 are over a T1 line. As in prior art systems, such as the one shown in FIG. 1, information is communicated between the router 34 and the colo/host client server farm 38 via a firewall. Preferably, a T1 link is used for communications between the router 34 and the firewall 36 and for communications between the firewall 36 and the colo/host client server farm 38.

The present invention transmits data from the Invisiwall™ device 40 to a local onsite Invisiwall™ network operations center (NOC) 42 where the telecommunications network is supervised, monitored and maintained. A typical NOC is a room that has visualizations of the network or networks that are being monitored and workstations at which detailed status can be viewed, as well as software required to manage the networks.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A network security device in communication with an Internet, comprising:
a) a housing having an internal surface and an external surface, the internal surface encasing circuitry for receiving data from the Internet and forwarding the received data to a router and a network operations center, wherein the data is forwarded to the router and the network operations center via straight through connections, whereby the network security device is invisible to devices on the Internet and thereby prevents attacks via the Internet;
b) a line in port on the external surface of the housing for accepting an Internet connection line, the Internet connection line configured to transfer data between the Internet and the network security device;
c) a line out port on the external surface of the housing for completing a path between the Internet and the network security device; and
d) a direct administration line on the external surface of the housing for providing a direct link to the network operations center.

2. The network security device of claim 1, further comprising an S-link on the external surface of the housing for connecting the network security device to another network security device.

3. The network security device of claim 1, further comprising at least one indicator for providing status of the network security device.

4. The network security device of claim 1, wherein the Internet connection line transfers data from a colocation host.

5. The network security device of claim 1, wherein the Internet connection line transfers data from a managed service provider.

6. The network security device of claim 1, wherein the Internet connection line transfers data from a data center host.

7. A method for a network security device to perform network security, the method comprising:
a) receiving data from an Internet; and
b) forwarding the data received from the Internet to a router and to a network operations center via direct connections between the network, whereby the network security device is invisible to devices on the Internet and thereby prevents attacks via the Internet.

8. The method of claim 7, further comprising providing a status indication at the network security device.

9. The method of claim 7, wherein the data received from the Internet is received via an Internet connection line.

10. The method of claim 9, wherein the Internet connection line transfers data from a colocation host.

11. The method of claim 9, wherein the Internet connection line transfers data from a managed service provider.

12. The method of claim 9, wherein the Internet connection line transfers data from a data center host.
